(19) United States
(12) Patent Application Publication
(10) Pub. No.: US 2015/0169551 A1
(43) Pub. Date: Jun. 18, 2015

(54) APPARATUS AND METHOD FOR AUTOMATIC TRANSLATION

(71) Applicant: ELECTRONICS AND TELECOMMUNICATIONS RESEARCH INSTITUTE, Daejeon-city (KR)

(72) Inventors: Seung YUN, Daejeon (KR); Sang-Hun KIM, Daejeon (KR); Mu-Yeol CHOI, Daejeon (KR)

(73) Assignee: ELECTRONICS AND TELECOMMUNICATIONS RESEARCH INSTITUTE, Daejeon-city (KR)

(21) Appl. No.: 14/521,962

(22) Filed: Oct. 23, 2014

(30) Foreign Application Priority Data
Dec. 13, 2013 (KR) 10-2013-0155310

(51) Int. Cl. G06F 17/28

(52) U.S. Cl. CPC G06F 17/289

(57) ABSTRACT

An apparatus and method for automatic translation are disclosed. In the apparatus for automatic translation, a User Interface (UI) generation unit generates UIs necessary for start of translation and a translation process. A translation target input unit receives a translation target to be translated from a user. A translation target translation unit translates the translation target received by the translation target input unit and generates results of translation. A display unit includes a touch panel for outputting the results of translation and the UIs in accordance with the location of the user.

### CROSS REFERENCE TO RELATED APPLICATION

This application claims the benefit of Korean Patent Application No. 10-2013-0155310, filed Dec. 13, 2013, which is hereby incorporated by reference in its entirety into this application.

### BACKGROUND OF THE INVENTION

1. Technical Field

The present invention relates generally to an apparatus and method for automatic translation. More particularly, the present invention relates to an apparatus and method for automatic translation, which can generate User Interfaces (UIs) enabling a user to conveniently execute the automatic translation apparatus, control the size of an output screen by taking the location of the user into consideration, and reflect proper nouns necessary to perform translation in accordance with the selection of the user.

2. Description of the Related Art

Recently, with the development of voice (speech) recognition and machine translation technologies and with the popular spread of wireless communication networks and smart phones, automatic translation apparatuses have been widely used in the form of the applications installed on mobile terminals.

Generally, a user executes such an automatic translation apparatus on a mobile terminal, and performs automatic translation through voice recognition or text input in accordance with the configuration of the UI of a relevant application, thereby acquiring results of automatic translation.

Such a conventional automatic translation apparatus may not acquire the results of automatic translation without running a separate application, and thus there is a problem in that it is difficult to satisfy a user's desire to perform automatic translation at any time as the utilization of automatic translation increases.

In contrast, when there is additional information for a user in addition to the results of automatic translation, it is necessary to conveniently provide the information to the user.

Further, when automatic translation is performed on a single mobile terminal, and a participating party has not used a relevant application or menus are not provided in the native language of the participating party, it is difficult to operate the application.

Further, upon performing automatic translation, all available vocabulary may be targets for voice recognition and machine translation.

That is, when the number of proper nouns, such as place names or company names in the world, is taken into consideration, all general vocabulary is set to automatic translation targets, and proper nouns which are neither well-known nor essential are limited to proper nouns in a specific geographic area and are limitedly set to translation targets, thereby increasing automatic translation performance.

However, since proper nouns have been not taken into sufficient consideration, it is necessary to provide an apparatus and method for automatic translation, which can generate UIs enabling a user to conveniently execute the automatic translation apparatus, control the size of an output screen by taking the location of the user into consideration, and reflect proper nouns necessary to perform translation in accordance with the selection of the user. Korean Patent Application Publication No. 10-2013-0112654 discloses a related technology.

### SUMMARY OF THE INVENTION

Accordingly, the present invention has been made keeping in mind the above problems occurring in the prior art, and an object of the present invention is to provide User Interfaces (UIs) enabling a user to easily understand and access additional N-Best information for results of voice recognition, information about similar results of translation, and transcriptions allowing the user to personally pronounce a foreign language, in addition to results of automatic translation.

Another object of the present invention is to enable automatic translation to be efficiently and smoothly performed by effectively configuring an output screen to be split when automatic translation is performed between users having different native languages using an automatic translation apparatus according to the present invention.

A further object of the present invention is to provide a UI enabling a user to conveniently select a specific geographic area or to reflect proper nouns in the specific geographic area based on the location of the user when desiring to reflect proper nouns in the specific area in order to increase automatic translation performance.

In accordance with an aspect of the present invention to accomplish the above objects, there is provided an apparatus for automatic translation including a User Interface (UI) generation unit for generating UIs necessary for start of translation and a translation process; a translation target input unit for receiving a translation target to be translated from a user; a translation target translation unit for translating the translation target received by the translation target input unit and generating results of translation; and a display unit including a touch panel outputting the results of translation and the UIs in accordance with a location of the user.

The UI generation unit may include a determination unit for determining whether or not a user-designated translation start UI, designated by the user in advance to start translation, is present in a database; a default UI generation unit for generating a default UI when it is determined by the determination unit that the user-designated translation start UI is not present in the database; and a control unit for controlling the display unit such that the default UI generated by the default UI generation unit is output on the display unit.

The control unit may perform control such that the user-designated translation start UI is output on the display unit when it is determined by the determination unit that the user-designated translation start UI is present in the database.

The translation target input unit may include a text input unit for receiving the translation target through text input from the user; and a voice input unit for receiving the translation target through voice input from the user.

The UI generation unit may further include a translation UI generation unit for generating UIs necessary for the translation process, the translation UI generation unit may generate a text input UI or a voice input UI for selecting text input or voice input when the user inputs the translation target, and the control unit may perform control such that the text input UI and the voice input UI are output on the display unit.

The display unit may simultaneously output the translation target and the results of translation.

The translation target translation unit may generate a plurality of different results of translation for the translation target, the UI generation unit may generate translation result UIs corresponding to a number of plurality of different results of translation and, and when the user touches the translation result UIs output on the display unit, the plurality of different results of translation may be output on the display unit.

The translation target translation unit may generate information about phonetic symbols corresponding to the results of translation, and the display unit may output the information about the phonetic symbols.

The display unit may simultaneously output a first output area configured to include a first translation result and a first UI and a second output area vertically inverted from the first output area.

The display unit may change and output the first output area based on a location of a first user who is located at an upper portion of the display unit, and change and output the second output area based on a location of a second user who is located at a lower portion of the display unit.

The display unit may output the first output area after changing a size of the first output area in accordance with a distance between the first user and the display unit based on sensors located in a vicinity of the display unit, and output the second output area after changing a size of the second output area in accordance with a distance between the second user and the display unit.

The display unit may enlarge the size of the second output area after results of translation performed by the first user are output, and enlarge the size of the first output area after results of translation performed by the second user are output.

The UI generation unit may generate a voice recognition result UI corresponding to results of voice recognition when the translation target is voice input from the user, and generate a candidate voice recognition result UI corresponding to results of candidate voice recognition similar to the results of voice recognition when the user touches the voice recognition result UI output on the display unit, and the translation target translation unit may perform translation for the results of candidate voice recognition and generate the results of translation when the user touches the candidate voice recognition result UI.

The translation target translation unit may generate the results of translation after reflecting proper nouns for a language of a geographic area corresponding to the location of the user based on the location of the user.

The UI generation unit may generate a proper noun UI for selecting a proper noun of a specific geographic area to be reflected when the translation target translation unit generates the results of translation, and the translation target translation unit may generate the results of translation after reflecting the proper noun of the geographic area corresponding to the proper noun UI touched by the user.

The proper noun UI may be a globe-shaped UI including a plurality of geographic areas, and the translation target translation unit may generate the results of translation by reflecting a proper noun corresponding to a geographic area selected in such a way that the user rotates the globe-shaped UI through touching and dragging.

In accordance with another aspect of the present invention to accomplish the above objects, there is provided a method for automatic translation including generating, by an UI generation unit, UIs necessary for start of translation and a translation process; receiving, by a translation target input unit, a translation target to be translated from a user; performing translation, by a translation target translation unit, on the translation target received in receiving and generating results of translation; and outputting, by a display unit, the results of translation and the UIs in accordance with a location of the user.

Generating the results of translation may include generating a plurality of different results of translation performed on the translation target; generating translation result UIs corresponding to a number of the plurality of different results of translation; and outputting the translation result UIs after generating the results of translation.

The method may further include, after outputting the translation result UIs, outputting the plurality of different results of translation when the user touches the translation result UIs.

Outputting the translation result UIs may include simultaneously outputting a first output area configured to include a first translation result and a first UI and a second output area vertically inverted from the first output area.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a figure in which an automatic translation apparatus according to the present invention is utilized;

FIG. 2 is a block diagram illustrating the automatic translation apparatus according to the present invention;

FIG. 3 is a block diagram illustrating a User Interface (UI) generation unit of the automatic translation apparatus according to the present invention;

FIG. 4 is a flowchart illustrating an embodiment of the UI generation unit of the automatic translation apparatus according to the present invention;

FIG. 5 is a block diagram illustrating a translation target input unit of the automatic translation apparatus according to the present invention;

FIG. 6 is a flowchart illustrating a process of changing an UI in the automatic translation apparatus according to the present invention;

FIG. 7 is a flowchart illustrating a process of performing translation through text input from the user in the automatic translation apparatus according to the present invention.

FIG. 8 is a flowchart illustrating a process of performing translation through voice input from the user in the automatic translation apparatus according to the present invention;

FIG. 9 is a flowchart illustrating a process of correcting results of voice recognition performed in the automatic translation apparatus according to the present invention;

FIG. 10 is a view illustrating a display unit of the automatic translation apparatus according to the present invention;

FIGS. 11 to 13 are views illustrating a process of selecting results of input provided from the user and results of translation in the automatic translation apparatus according to the present invention;

FIG. 14 is a view illustrating a figure in which phonetic symbols are provided for the results of translation in the automatic translation apparatus according to the present invention;

FIG. 15 is a view illustrating a figure in which the output screen of the automatic translation apparatus according to the present invention is split;

FIG. 16 is a view illustrating a figure in which the sizes of the output screens of the automatic translation apparatus according to the present invention are changed based on the locations of users;

FIGS. 17 to 19 are views illustrating a figure in which the results of voice recognition are corrected in the automatic translation apparatus according to the present invention;

FIG. 20 is a flowchart illustrating a process of reflecting proper nouns of a specific geographic area in the automatic translation apparatus according to the present invention;

FIGS. 21 to 24 are views illustrating the output screen relevant to the process of reflecting proper nouns of a specific geographic area in the automatic translation apparatus according to the present invention; and

FIG. 25 is a flowchart illustrating an automatic translation method according to the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below.

The embodiments of the present invention are intended to fully describe the present invention to a person having ordinary knowledge in the art to which the present invention pertains. Accordingly, the shapes, sizes, etc. of components in the drawings may be exaggerated to make the description clearer.

In addition, when components of the present invention are described, terms, such as first, second, A, B, (a), and (b), may be used. The terms are used to only distinguish the components from other components, and the natures, sequences or orders of the components are not limited by the terms.

An automatic translation apparatus according to the present invention may be designed such that, when a user terminal, such as a mobile terminal, is used, a UI is caused not to be displayed on a screen of the mobile terminal and is maintained in a standby state in the background in accordance with setting of a user and such that translation is performed if voice input or text input is performed by the user.

Further, the automatic translation apparatus according to the present invention may be designed such that the UI is always exposed on the screen of the mobile terminal in the form of a minimized icon, and thus automatic translation is easily performed using the icon whenever translation is necessary.

Hereinafter, a figure in which the automatic translation apparatus according to the present invention is utilized will be described.

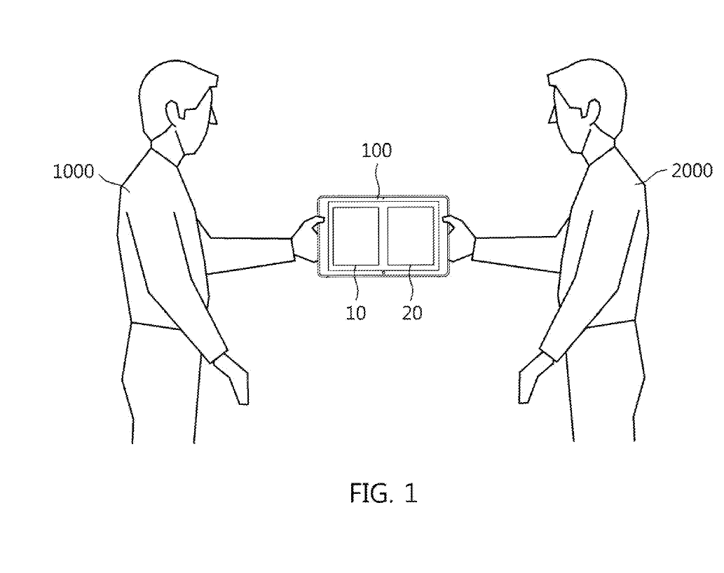

FIG. 1 is a diagram illustrating the figure in which the automatic translation apparatus according to the present invention is utilized.

Referring to FIG. 1, the screen of an automatic translation apparatus 100 according to the present invention is split.

More specifically, a screen output on the automatic translation apparatus 100 may include a first output area 10 and a second output area 20.

As above, as the output screen is split, a first user 1000 and a second user 2000 may easily talk with each other using the single automatic translation apparatus 100 according to the present invention.

More specifically, the first output area 10 and the second output area 20 may include the same output content in the form in which the first output area 10 and the second output area 20 are vertically inverted.

The first output area 10 may be formed to correspond to a direction in which the first user 1000 faces the automatic translation apparatus 100, and the second output area 20 may be formed to correspond to a direction in which the second user 2000 faces the automatic translation apparatus 100.

Further, the sizes of the screens of the first output area 10 and the second output area 20 may be changed to correspond to the locations of the first user 1000 and the second user 2000.

For example, when the first user 1000 is located close to the automatic translation apparatus 100 and the second user 2000 is located far away from the automatic translation apparatus 100, it is determined that the first user 1000 is using the automatic translation apparatus, and thus control may be performed such that the size of the screen of the first output area 10 is larger.

That is, when the first user 1000 and the second user 2000 talk with each other by alternately performing translation, if the second user 2000 finishes speaking, the first user 1000 approaches the automatic translation apparatus 100 according to the present invention at speaking time of the first user 1000, and thus the size of the screen of the first output area 10 output in the direction of the first user 1000 is changed to be large.

Here, the locations of the first user 1000 and the second user 2000 may be determined using sensors mounted on the automatic translation apparatus 100 according to the present invention.

Here, gyro sensors may be used as the sensors. If the gyro sensors are used, the sizes or angles of the screens of the first output area 10 and the second output area 20 may be controlled based on the slope of the automatic translation apparatus 100 according to the present invention.

The output screen, which is split into the above-described first output area 10 and the second output area 20, will be described in detail later with reference to the accompanying drawings.

Hereinafter, the components and operational principle of the automatic translation apparatus according to the present invention will be described.

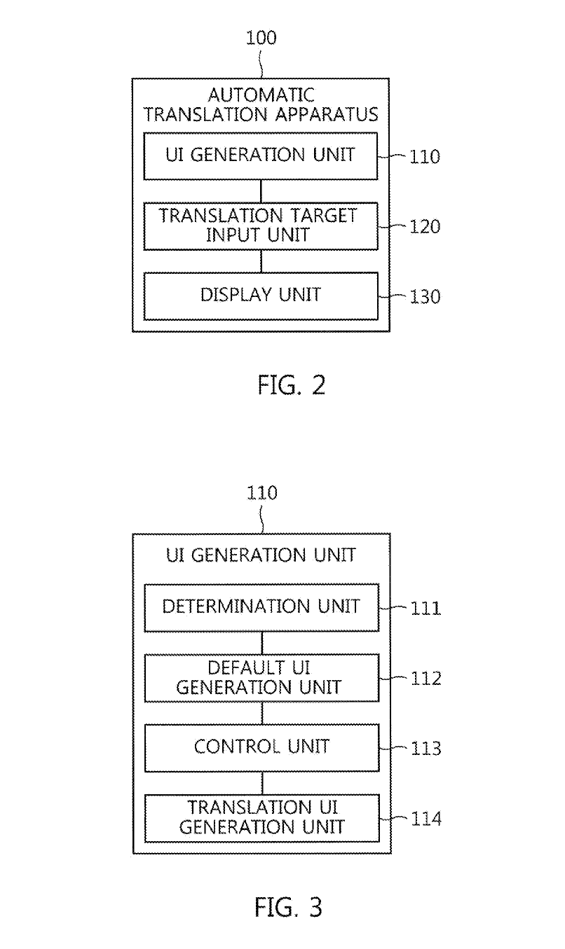

FIG. 2 is a block diagram illustrating the automatic translation apparatus according to the present invention.

Referring to FIG. 2, the automatic translation apparatus 100 according to the present invention includes a User Interface (UI) generation unit 110, a translation target input unit 120, and a display unit 130.

More specifically, the UI generation unit 110 of the automatic translation apparatus 100 according to the present invention generates UIs which are necessary for the start of translation and a translation process. The translation target input unit 120 receives a translation target to be translated from a user. A translation target translation unit translates the translation target received by the translation target input unit 120 and generates results of translation. The display unit 130 includes a touch panel for outputting the results of translation and the UIs in accordance with the location of the user.

The UI generation unit 110 performs a function of generating UIs necessary for the start of translation and the translation process.

Here, the start of translation means a command to start translation in the automatic translation apparatus 100 according to the present invention, and such a command for the start of translation is executed through the UIs.

Further, the translation process means a series of processes other than the above-described start of translation in a general procedure for performing translation, and UIs corresponding to respective commands are necessary for the commands for performing translation.

Therefore, the UI generation unit 110 generates the UI necessary for the start of translation, and the UIs necessary for the process of performing translation after translation starts.

As described above, the automatic translation apparatus 100 according to the present invention may be a mobile terminal Therefore, in a case of a smart phone, which is a kind of mobile terminal, translation may be performed through a process of touching or dragging a UI for the start of translation at the point of time that translation is necessary, such as when making a typical phone call or executing another application.

Such a command for the start of translation may be designated by a user. When the user does not designate the command in advance, the UI generation unit 110 may generate a default UI and may output the default UI on the display unit 130.

Below, the UI generation unit 110 will be described in detail with reference to the drawings.

FIG. 3 is a block diagram illustrating the UI generation unit of the automatic translation apparatus according to the present invention.

Referring to FIG. 3, the UI generation unit 110 includes a determination unit 111, a default UI generation unit 112, a control unit 113, and a translation UI generation unit 114.

More specifically, the determination unit 111 performs a function of determining whether or not a user-designated translation start UI, which is a UI designated by a user in advance for the start of translation, is present in a database (DB).

The default UI generation unit 112 performs a function of generating a default UI when it is determined, by the determination unit 111, that the user-designated translation start UI is not present in the DB.

The control unit 113 performs a function of controlling the display unit 130 such that the default UI generated by the default UI generation unit 112 is output on the display unit 130.

Further, the control unit 113 may perform control such that the user-designated translation start UI is output on the display unit 130 when it is determined, by the determination unit 111, that the user-designated translation start UI is present in the database.

Furthermore, the translation UI generation unit 114 performs a function of generating UIs necessary for the translation process and a function of generating a text input UI and a voice input UI for selecting text input or voice input when the user inputs a translation target.

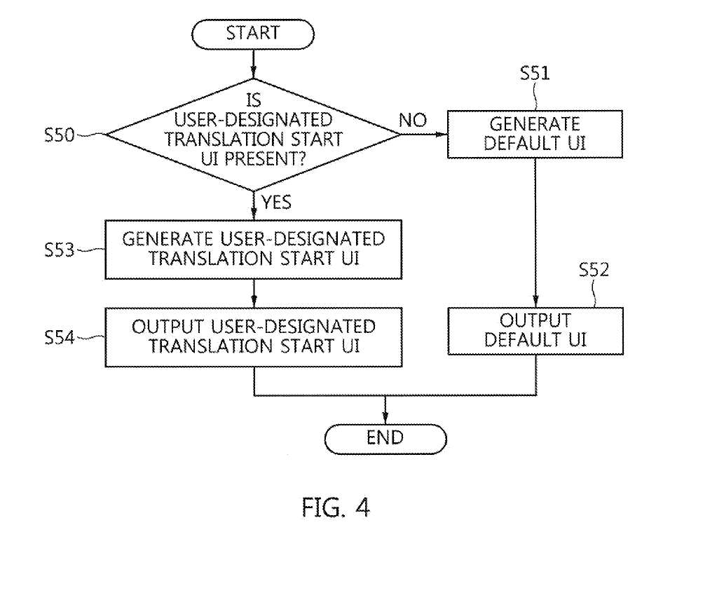

FIG. 4 is a flowchart illustrating an embodiment of the UI generation unit of the automatic translation apparatus according to the present invention.

The embodiment of the UI generation unit will be described with reference to FIG. 4. The determination unit 111 determines whether or not a user-designated translation start UI is present at step S50.

Here, the user-designated translation start UI means a UI for the start of translation in the automatic translation apparatus 100 according to the present invention.

Here, when it is determined that the user-designated translation start UI is not present in the DB of the automatic translation apparatus 100 according to the present invention, the default UI generation unit 112 generates a default UI at step S51, and the control unit 113 performs control such that the default UI generated by the default UI generation unit 112 is output on the display unit 130.

However, when the determination unit 111 determines that the user-designated translation start UI is present in the DB, a user-designated translation start UI is generated at step S53. Here, “generated” means that the user-designated translation start UI which is present in the DB is fetched.

When the user-designated translation start UI is generated, the control unit 113 performs control such that the user-designated translation start UI is output on the display unit 130 at step S54.

As above, when the user-designated translation start UI is generated, the automatic translation apparatus 100 according to the present invention starts in such a way that the user touches or drags the user-designated translation start UI.

FIG. 6 is a flowchart illustrating a process of changing an UI in the automatic translation apparatus according to the present invention.

The process of changing an UI will be described with reference to FIG. 6. In order for the user to change the user-designated translation start UI or the default UI generated as above, the user makes a request to change a UI at step S60, a user-designated translation start UI is stored in the DB by inputting or selecting a desired user-designated translation start UI at step S61, and then the user-designated translation start UI stored in the DB is changed at step S62 and is then output on the display unit 130.

Below, the translation target input unit 120 of the automatic translation apparatus 100 according to the present invention will be described in detail with reference to the drawings.

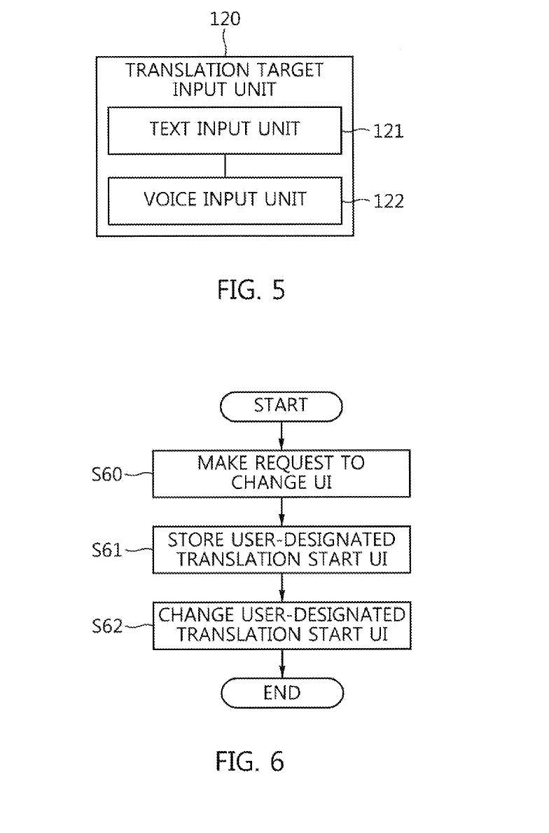

FIG. 5 is a block diagram illustrating the translation target input unit of the automatic translation apparatus according to the present invention.

Referring to FIG. 5, the translation target input unit 120 of the automatic translation apparatus 100 according to the present invention includes a text input unit 121 and a voice input unit 122.

More specifically, the translation target input unit 120 performs a function of receiving a translation target to be translated from a user.

When the translation target is received from the user, the text input unit 121 operates if the user inputs the translation target in the form of text, and the voice input unit 122 operates if the user inputs the translation target in the form of voice.

Hereinafter, an embodiment of a process of receiving the translation target from the user in the automatic translation apparatus according to the present invention will be described.

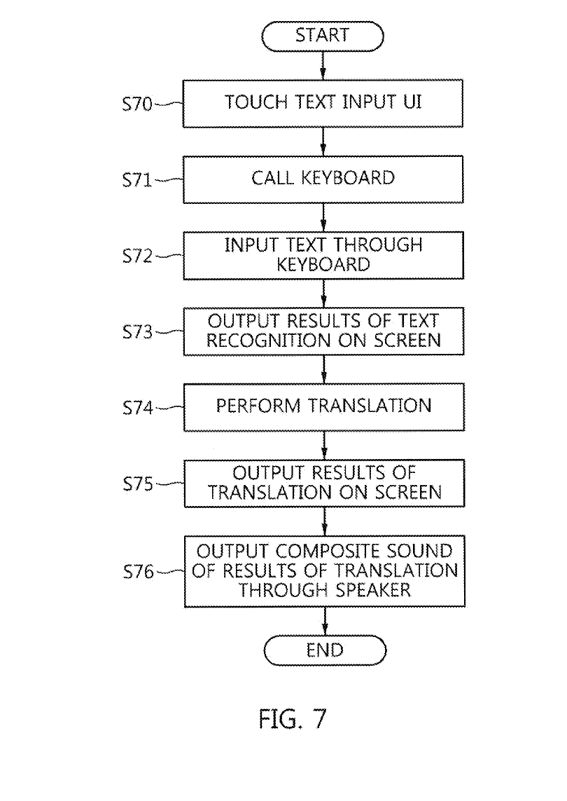

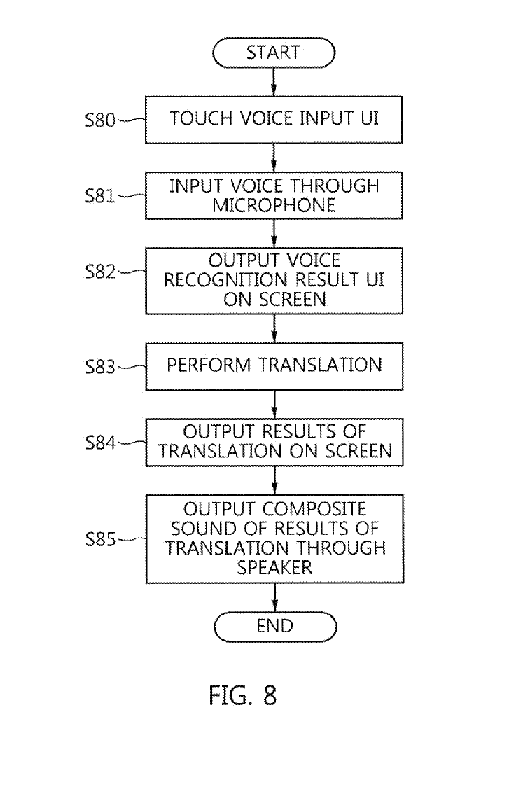

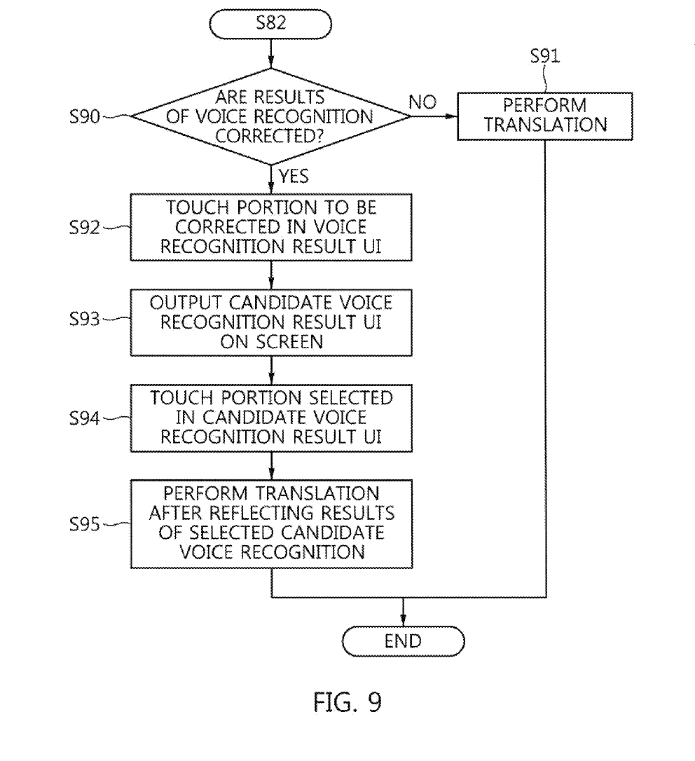

FIG. 7 is a flowchart illustrating a process of performing translation through text input from the user in the automatic translation apparatus according to the present invention. FIG. 8 is a flowchart illustrating a process of performing translation through voice input from the user in the automatic translation apparatus according to the present invention. FIG. 9 is a flowchart illustrating a process of correcting results of voice recognition performed in the automatic translation apparatus according to the present invention.

Referring to FIG. 7, the user touches the text input UI which is present in the display unit 130 of the automatic translation apparatus 100 according to the present invention at step S70. Here, when the user touches the text input UI, a keyboard is called at step S71.

Here, the called keyboard means a UI for performing text input by the user.

Here, if the user inputs text through the called keyboard at step S72, the automatic translation apparatus 100 according to the present invention recognizes the text input by the user and outputs results of text recognition on the screen at step S73.

Thereafter, the text input by the user and output on the screen is confirmed as a translation target, translation for the translation target is performed at step S74, and results of translation are output on the display unit 130 at step S75.

Further, when the user wants to listen to the pronunciation of the results of the translation, the composite sounds of the results of translation may be output through a speaker by the user touching or dragging a predetermined UI at step S76.

Here, the speaker means either a speaker mounted on the automatic translation apparatus 100 according to the present invention or a speaker as an external device connected to the automatic translation apparatus 100 through a cable.

Referring to FIG. 8, the user touches or drags the voice input UI in order to input the translation target in the form of voice at step S80. Here, the user inputs voice through a microphone mounted on the automatic translation apparatus 100 according to the present invention at step S81. When the voice of the user is input, the automatic translation apparatus 100 according to the present invention outputs a voice recognition result UI on the display unit 130 in order to determine whether or not the voice input by the user is correctly recognized.

Here, the microphone means either a microphone mounted on the automatic translation apparatus 100 according to the present invention or a microphone as an external device connected to the automatic translation apparatus 100 through a cable.

Here, when the user checks the voice recognition result UI and determines that the voice recognition has been performed correctly, translation is performed by touching or dragging a predetermined translation UI at step S83.

After translation is performed, results of translation are output on the display unit 130 at step S84. As described above, the composite sounds of the results of translation may be output through a speaker at step S85.

Here, the speaker means either a speaker mounted on the automatic translation apparatus 100 according to the present invention or a speaker as an external device connected to the automatic translation apparatus 100 through a cable.

Referring to FIG. 9, after the process at step S82 is performed, the user determines whether or not to correct the results of voice recognition. Here, when the user determines not to correct the results of voice recognition, the translation target is confirmed and translation is performed based on the voice recognition result UI at step S91.

In contrast, when the user determines to correct the results of voice recognition, that is, when the translation target input in the form of voice by the user is different from the translation target recognized by the automatic translation apparatus 100 according to the present invention, the user touches or drags a portion to be corrected in the voice recognition result UI at step S92.

Here, a candidate voice recognition result UI for a portion of the translation target to be corrected is output on the screen at step S93.

Then, the user touches a selected portion in the candidate voice recognition result UI at step S94. Thereafter, translation is performed after reflecting the results of voice recognition of the selected candidate at step S95.

A detailed embodiment of the output screen acquired in the above-described process of receiving the translation target will be described later with reference to other drawings.

Below, the display unit of the automatic translation apparatus according to the present invention will be described.

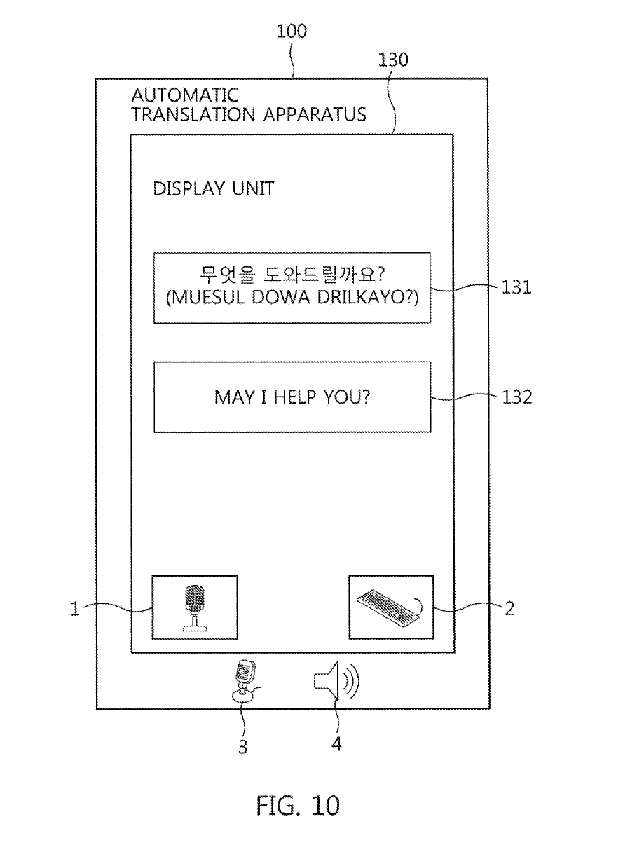

FIG. 10 is a view illustrating the display unit of the automatic translation apparatus according to the present invention.

The display unit 130 performs a function of outputting the results of translation and the UIs in accordance with the location of the user, and includes a touch panel.

The display unit 130 may simultaneously output a first output area including a first translation result and a first UI and a second output area which is vertically inverted from the first output area.

Further, the display unit 130 may change and output the first output area based on the location of a first user who is located at the upper portion of the display unit 130, and may change and output the second output area based on the location of a second user who is located at the lower portion of the display unit 130.

Here, the display unit 130 may output the first output area after changing the size of the first output area in accordance with the distance between the first user and the display unit based on location sensors located in the vicinity of the display unit 130, and may output the second output area after changing the size of the second output area in accordance with the distance between the second user and the display unit.

Here, the display unit 130 may enlarge the size of the second output area after the results of translation performed with the first user are output, and may enlarge the size of the first output area after the results of translation performed with the second user are output.

Referring to FIG. 10, the automatic translation apparatus 100 according to the present invention includes the display unit 130, which includes a voice recognition result UI 131, a translation result UI 132, a voice input UI 1, and a text input UI 2.

Further, it may be seen that the automatic translation apparatus 100 is provided with a microphone 3 and a speaker 4.

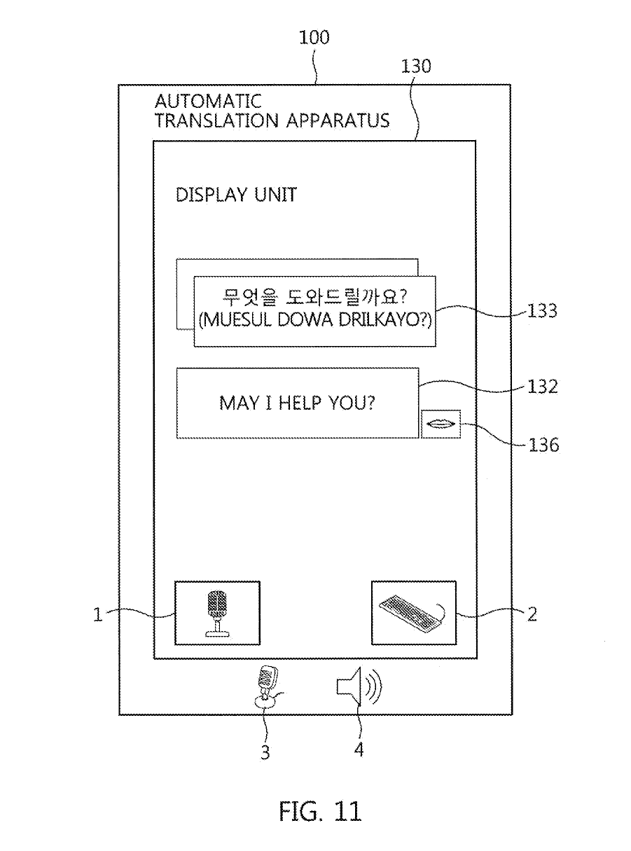

FIGS. 11 to 13 are views illustrating a process of selecting the results of input provided from the user and the results of translation in the automatic translation apparatus according to the present invention.

Referring to FIG. 11, it may be seen that there is an N-Best UI 133 including a plurality of results recognized by the automatic translation apparatus according to the present invention for a translation target input in the form of voice by the user.

That is, the automatic translation apparatus according to the present invention may recognize a plurality of candidate sentences for the translation target input in the form of voice by the user. Here, the N-Best UI 133 may generate UIs to intuitively perceive how many candidate sentences are present.

For example, numerical information may be expressed on the UI or overlapping screens may be expressed.

Further, it may be seen that there is a phonetic symbol UI 136.

When the user touches the phonetic symbol UI 136, phonetic symbols for the results of translation are output on the display unit 130.

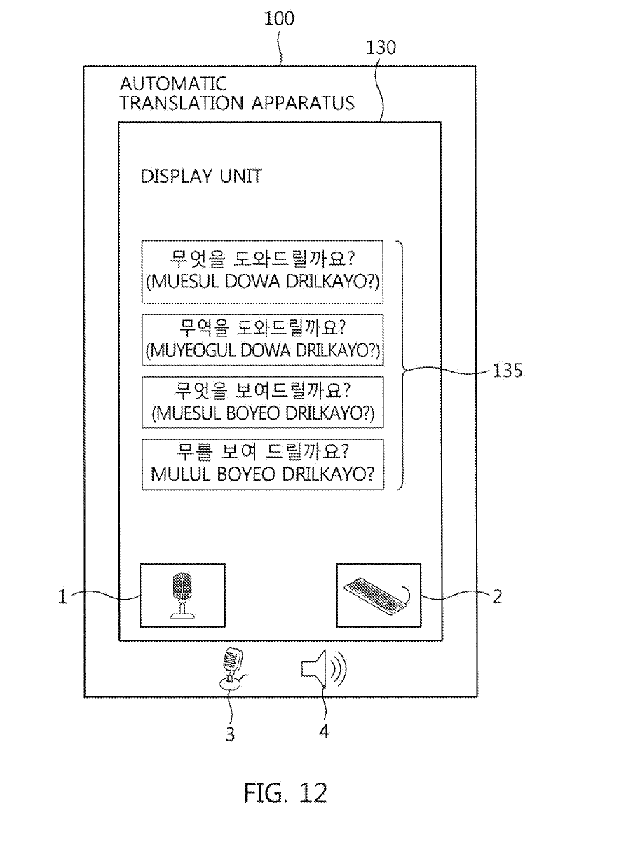

Referring to FIG. 12, an output screen acquired after the user touches the N-Best UI 133 may be seen.

That is, when the user touches the N-Best UI 133, the automatic translation apparatus 100 according to the present invention outputs a plurality of candidates 135 acquired by recognizing the user's voice.

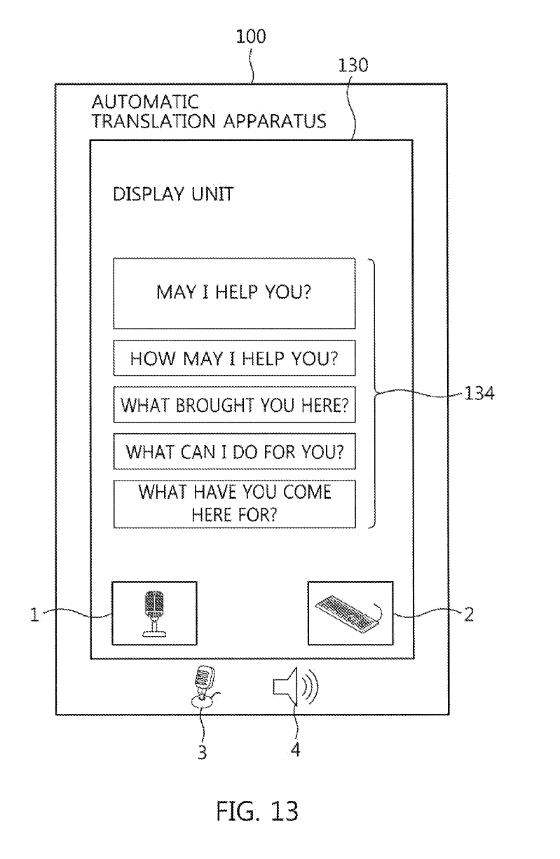

Referring to FIG. 13, an output screen acquired after the user touches the translation result UI 132 may be seen.

That is, when the user touches translation result UI 132, a plurality of candidates 134 of the results of translation performed by the automatic translation apparatus 100 according to the present invention is output.

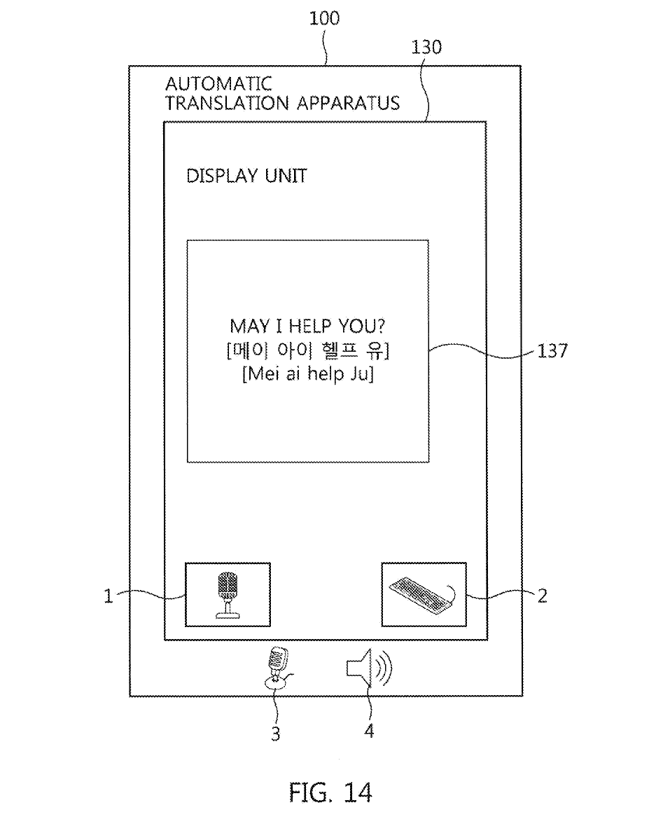

FIG. 14 is a view illustrating a figure in which phonetic symbols are provided for the result of translation in the automatic translation apparatus according to the present invention;

Referring to FIG. 14, an output screen acquired after the user touches the phonetic symbol UI 136 may be seen.

That is, when the user touches the phonetic symbol UI, the display unit 130 of the automatic translation apparatus 100 according to the present invention outputs phonetic symbols 137 corresponding to the result of translation.

Below, a figure in which the output screen of the automatic translation apparatus according to the present invention is split will be described.

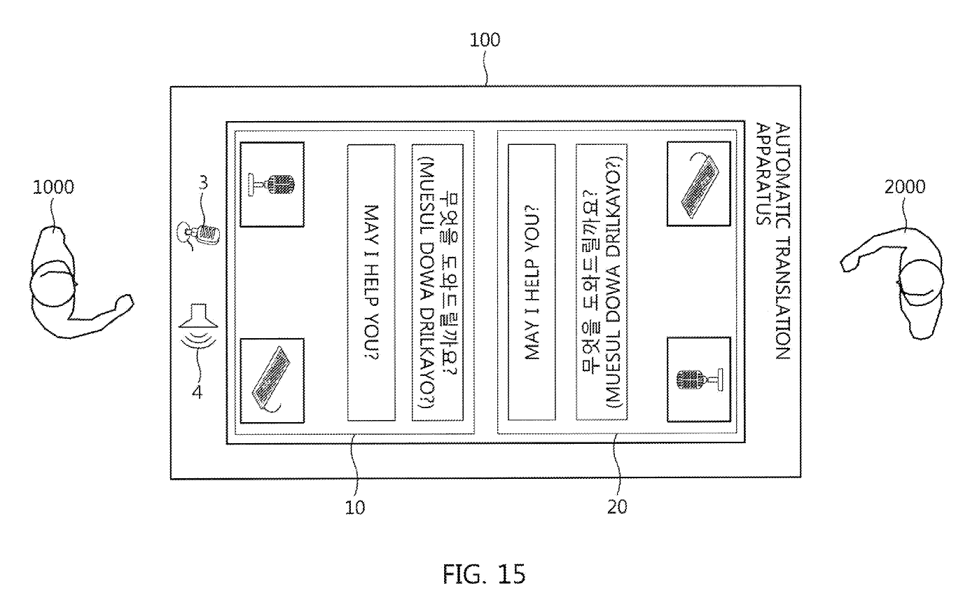

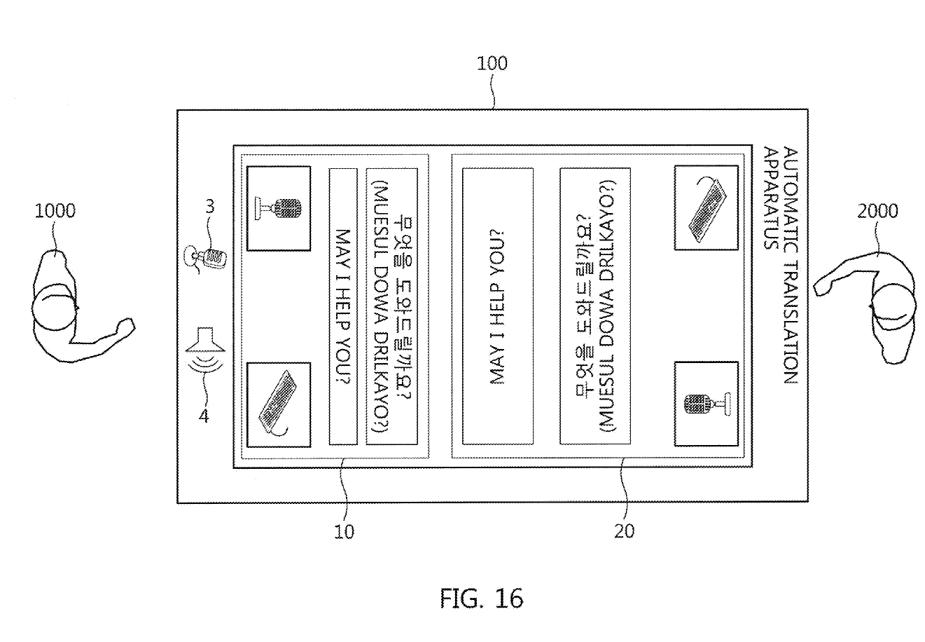

FIG. 15 is a view illustrating the figure in which the output screen of the automatic translation apparatus according to the present invention is split. FIG. 16 is a view illustrating a figure in which the sizes of the output screens of the automatic translation apparatus according to the present invention are changed based on the locations of users.

More specifically, the screen output on the automatic translation apparatus 100 may include the first output area 10 and the second output area 20.

As above, when the output screen is split, the first user 1000 and the second user 2000 may easily talk with each other using the single automatic translation apparatus 100 according to the present invention.

More specifically, the first output area 10 and the second output area 20 may include the same output content in the form in which the first output area 10 and the second output area 20 are vertically inverted.

The first output area 10 may be formed in accordance with a direction in which the first user 1000 faces the automatic translation apparatus 100, and the second output area 20 may be formed in accordance with a direction in which the second user 2000 faces the automatic translation apparatus 100.

Further, the respective sizes of the screens of the first output area 10 and the second output area 20 may change in accordance with the locations of the first user 1000 and the second user 2000.

Referring to FIG. 16, it may be seen that the second user 2000 is located closer to the automatic translation apparatus 100 and the first user 1000 is located far from the automatic translation apparatus 100.

In this case, it is determined that the second user 2000 uses the automatic translation apparatus, and thus control may be performed such that the size of the second output area 20 is larger.

That is, when the first user 1000 and the second user 2000 talk with each other by alternately performing translation, if the first user 1000 finishes speaking, the second user 2000 approaches the automatic translation apparatus 100 according to the present invention at speaking time of the second user 2000, and thus the size of the screen of the second output area 20 output in the direction of the second user 2000 is changed to be large.

Here, the locations of the first user 1000 and the second user 2000 may be determined using sensors mounted on the automatic translation apparatus 100 according to the present invention.

Here, gyro sensors may be used as the sensors. When the gyro sensors are used, the sizes or angles of the screens of the first output area 10 and the second output area 20 may be controlled in accordance with the slope of the automatic translation apparatus 100 according to the present invention.

Below, a figure in which the results of voice recognition are corrected in the automatic translation apparatus according to the present invention will be described.

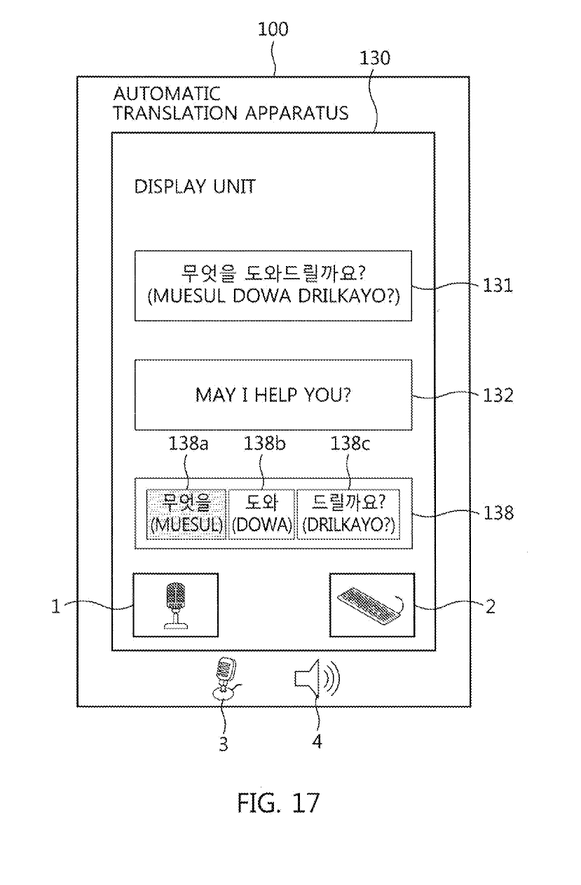

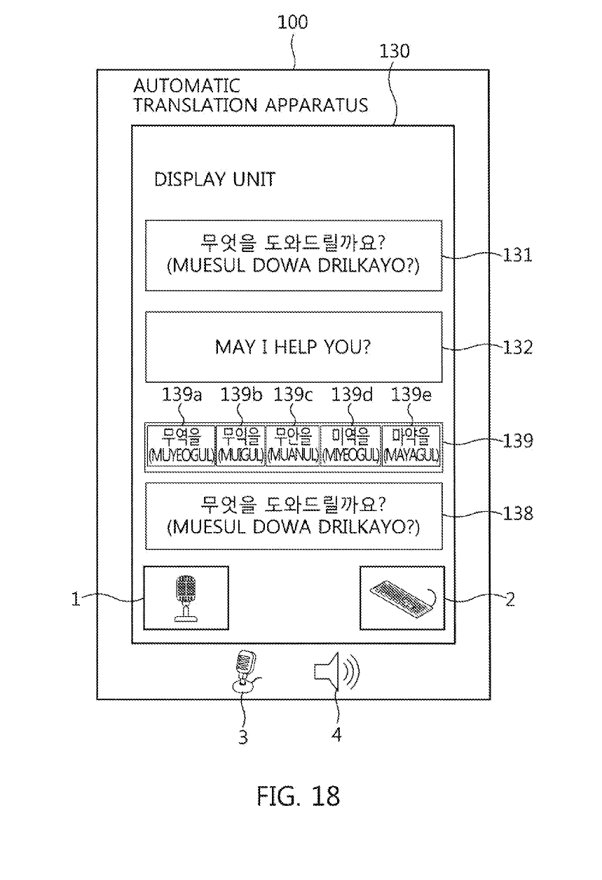

FIGS. 17 to 19 are views illustrating the figure in which the results of voice recognition are corrected in the automatic translation apparatus according to the present invention.

Referring to FIG. 17, when the user touches the voice recognition result UI 131, a copy UI 138 of the voice recognition result UI 131 is generated. When the user touches a portion 138a to be corrected in the copy UI 138, a candidate voice recognition result UI 139 corresponding to the touched portion 138a is generated.

Here, when the user touches a portion 139a to be corrected in the candidate voice recognition result UI 139, the corresponding portion is changed and then translation is performed.

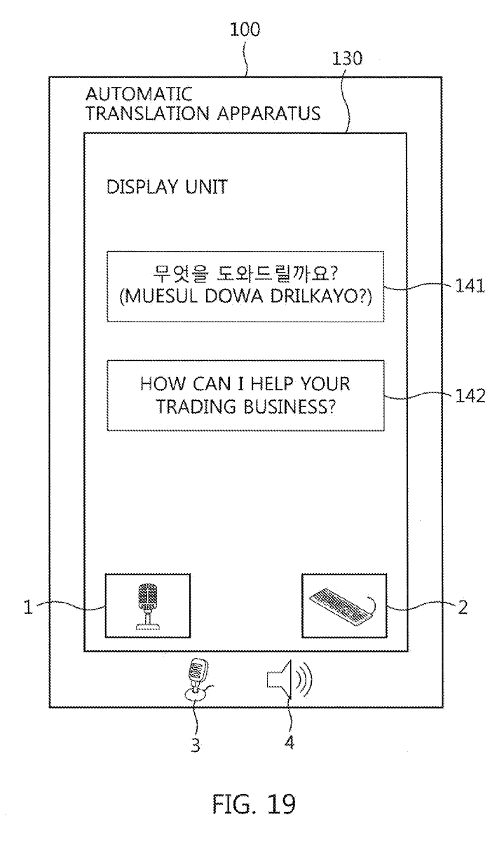

Therefore, referring to FIG. 19, the results of voice recognition for a translation target input in the form of voice by the user are recognized as “ [symbol] [symbol] (muesul dowa drilkayo)” in Korean. However, at the correction request of the user, “ [symbol] (muesul)” is corrected to “ [symbol] (muyeogul)”, and thus “ [symbol] [symbol] (muyeogul dowa drilkayo)?” is confirmed as the translation target as a result.

Therefore, referring to FIG. 19, it may be seen that the translation target of “ [symbol] (muyeogul dowa drilkayo)?” is translated to “How can I help your trading business?”

Hereinafter, a process of reflecting proper nouns of a specific geographic area to the automatic translation apparatus according to the present invention will be described.

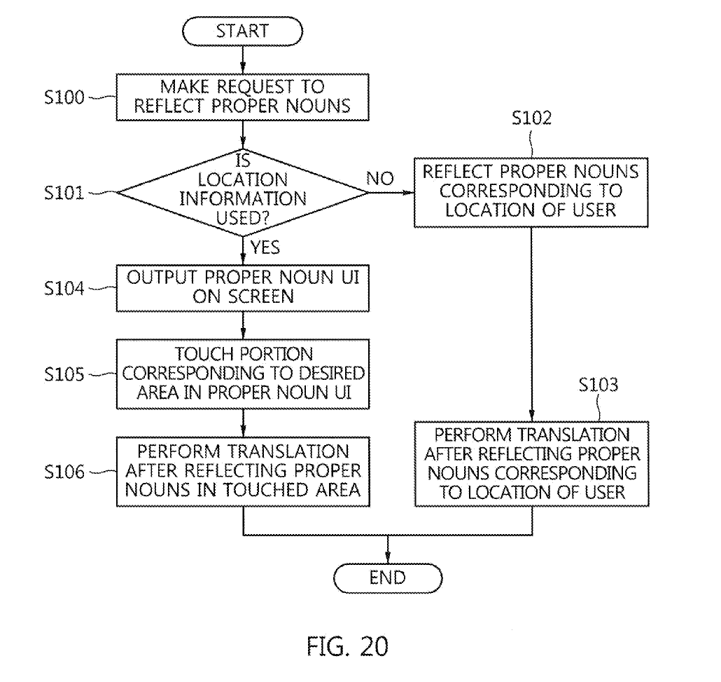

FIG. 20 is a flowchart illustrating the process of reflecting proper nouns of a specific geographic area to the automatic translation apparatus according to the present invention.

Referring to FIG. 20, the user makes a request to reflect a proper noun at step S100, and it is determined whether or not to use location information when the proper noun is reflected at step S101.

Here, “the use of location information” means the use of a GPS reception function mounted on the automatic translation apparatus 100 according to the present invention.

Here, when the user selects to use the location information, it is determined that proper nouns in a user located area are reflected based on the location information of the user at step S102, and translation is performed after reflecting the proper nouns in the area corresponding to the location of the user at step S103.

In contrast, when the user selects not to use the location information, a proper noun UI is output on the screen at step S104. When the user touches a portion corresponding to a desired area of the user in the proper noun UI at step S105, translation is performed after proper nouns in the touched area are reflected at step S106.

Hereinafter, an output screen relevant to the process of reflecting proper nouns of a specific geographic area in the automatic translation apparatus according to the present invention will be described with reference to the drawings.

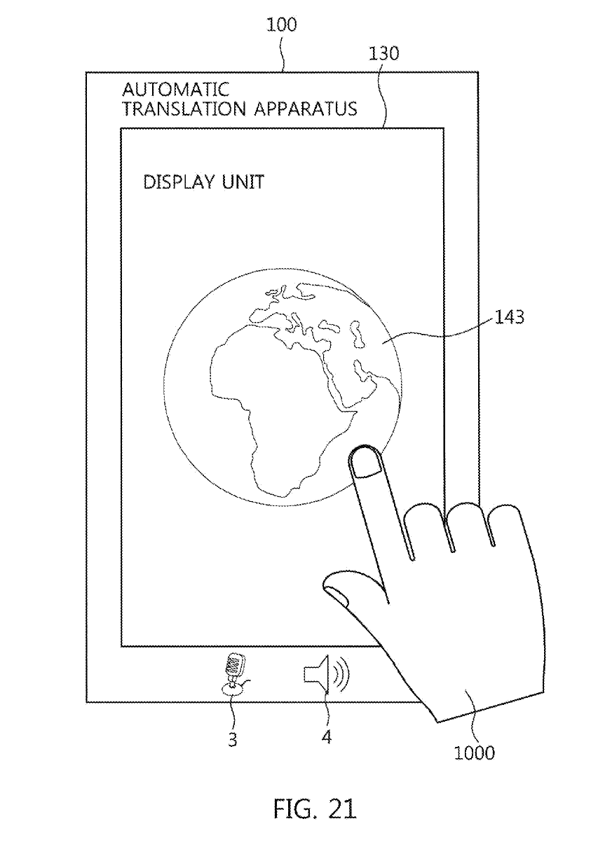

FIGS. 21 to 24 are views illustrating the output screen relevant to the process of reflecting proper nouns of the specific geographic area in the automatic translation apparatus according to the present invention.

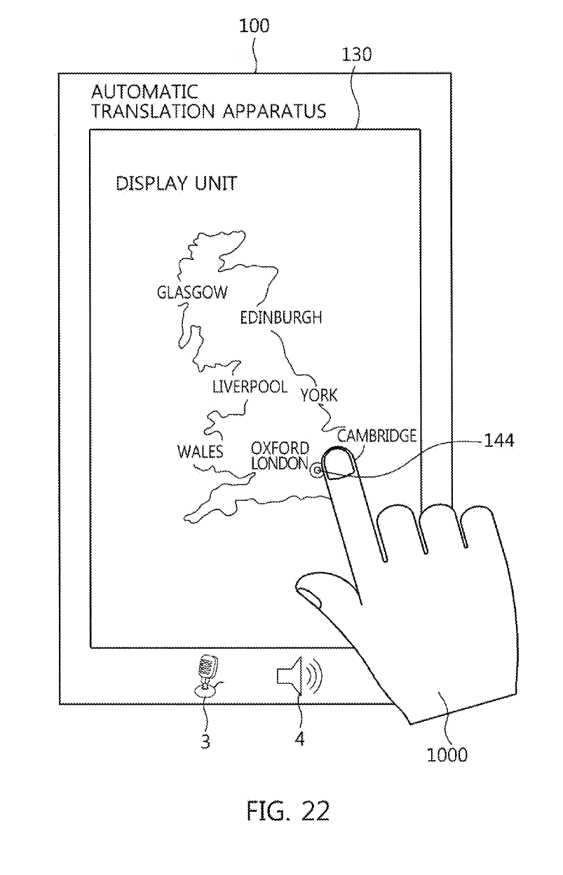

More specifically, referring to FIGS. 21 and 22 together, the user 1000 may select a desired geographic area by rotating and enlarging a globe-shaped UI 143 through touch and drag. Proper nouns of a city or area 144 selected in the above-described manner may be reflected when translation is performed.

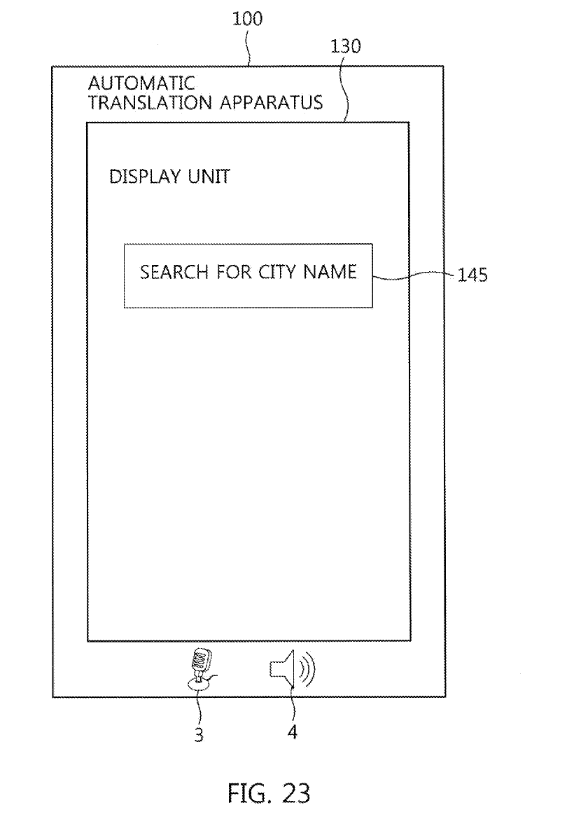

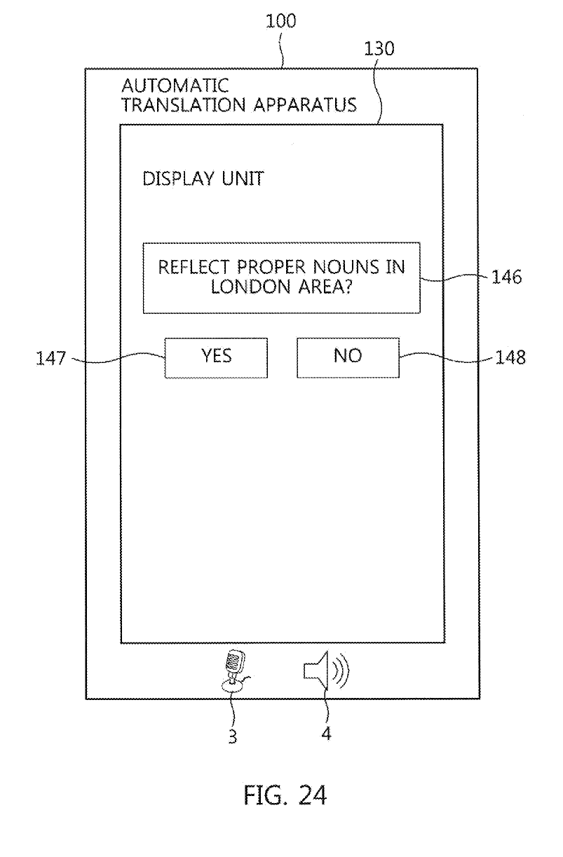

Further, referring to FIGS. 23 and 24 together, when the user touches a city name searching UI 145 and inputs a desired geographic area, translation may be performed after proper nouns in the selected area are reflected.

Referring to FIG. 24, a screen 146 for determining whether or not to reflect the area selected through the input of the user is output. Here, when the user selects YES 147 of YES 147 and NO 148, translation is performed after proper nouns of the London area are reflected.

Hereinafter, an automatic translation method according to the present invention will be described. As described above, the same technical content as that of the automatic translation apparatus 100 according to the present invention will not be repeatedly described.

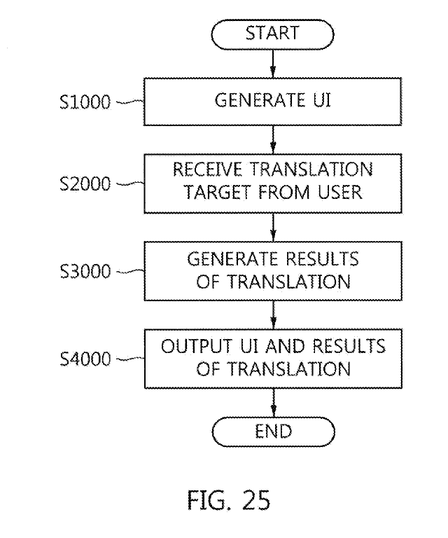

FIG. 25 is a flowchart illustrating an automatic translation method according to the present invention.

Referring to FIG. 25, the automatic translation method according to the present invention includes generating, by the UI generation unit, UIs necessary for the start of translation and the translation process at step S1000; receiving, by the translation target input unit, a translation target to be translated from a user at step S2000; performing translation, by the translation target translation unit, on the received translation target in receiving, and generating results of translation at step S3000; and outputting, by the display unit, the results of translation and the UIs in accordance with the location of the user at step S4000.

Here, generating the results of translation at step S3000 may further include generating a plurality of different results of translation for the translation target, generating translation result UIs corresponding to the number of plurality of different results of translation and outputting the translation result UIs after generating the results of translation at step S3000.

Further, the method may further include outputting the plurality of different results of translation when the user touches the translation result UIs after outputting the translation result UIs at step S4000.

Further, outputting the translation result UIs at step S4000 may include simultaneously outputting a first output area including first translation result and a first UI and a second output area which is vertically inverted from the first output area.

According to the present invention, there is an advantage in that it is possible to provide User Interfaces (UIs) enabling a user to easily understand and access additional N-Best information, information about similar results of translation for voice recognition results, and transcriptions allowing the user to directly pronounce a foreign language in addition to results of automatic translation.

Further, according to the present invention, there is another advantage in that automatic translation may be effectively and smoothly performed by effectively configuring an output screen to be split when automatic translation is performed between users having different native languages using the automatic translation apparatus according to the present invention.

Further, according to the present invention, there is still another advantage in that it is possible to provide an UI enabling a user to conveniently select a specific geographic area or to reflect proper nouns in a specific geographic area based on the location of the user when proper nouns in the specific area are reflected in order to increase automatic translation performance.

As described above, the apparatus and method for automatic translation according to the present invention are not limited and applied to the configurations and operations of the above-described embodiments, but all or some of the embodiments may be selectively combined and configured so that the embodiments may be modified in various ways.

What is claimed is:

1. An apparatus for automatic translation comprising:
a User Interface (UI) generation unit for generating UIs necessary for start of translation and a translation process;
a translation target input unit for receiving a translation target to be translated from a user;
a translation target translation unit for translating the translation target received by the translation target input unit and generating results of translation; and
a display unit including a touch panel outputting the results of translation and the UIs in accordance with a location of the user.

2. The apparatus of claim 1, wherein the UI generation unit comprises:
a determination unit for determining whether or not a user-designated translation start UI, designated by the user in advance to start translation, is present in a database;
a default UI generation unit for generating a default UI when it is determined by the determination unit that the user-designated translation start UI is not present in the database; and
a control unit for controlling the display unit such that the default UI generated by the default UI generation unit is output on the display unit.

3. The apparatus of claim 2, wherein the control unit performs control such that the user-designated translation start UI is output on the display unit when it is determined by the determination unit that the user-designated translation start UI is present in the database.

4. The apparatus of claim 1, wherein the translation target input unit comprises:
a text input unit for receiving the translation target through text input from the user; and
a voice input unit for receiving the translation target through voice input from the user.

5. The apparatus of claim 4, wherein:
the UI generation unit further comprises a translation UI generation unit for generating UIs necessary for the translation process,
the translation UI generation unit generates a text input UI or a voice input UI for selecting text input or voice input when the user inputs the translation target, and
the control unit performs control such that the text input UI and the voice input UI are output on the display unit.

6. The apparatus of claim 5, wherein the display unit simultaneously outputs the translation target and the results of translation.

7. The apparatus of claim 1, wherein:
the translation target translation unit generates a plurality of different results of translation for the translation target,
the UI generation unit generates translation result UIs corresponding to a number of plurality of different results of translation and, and
when the user touches the translation result UIs output on the display unit, the plurality of different results of translation are output on the display unit.

8. The apparatus of claim 1, wherein:
the translation target translation unit generates information about phonetic symbols corresponding to the results of translation, and
the display unit outputs the information about the phonetic symbols.

9. The apparatus of claim 1, wherein the display unit simultaneously outputs a first output area configured to include a first translation result and a first UI and a second output area vertically inverted from the first output area.

10. The apparatus of claim 9, wherein the display unit changes and outputs the first output area based on a location of a first user who is located at an upper portion of the display unit, and changes and outputs the second output area based on a location of a second user who is located at a lower portion of the display unit.

11. The apparatus of claim 10, wherein the display unit outputs the first output area after changing a size of the first output area in accordance with a distance between the first user and the display unit based on sensors located in a vicinity of the display unit, and outputs the second output area after changing a size of the second output area in accordance with a distance between the second user and the display unit.

12. The apparatus of claim 9, wherein the display unit enlarges the size of the second output area after results of translation performed by the first user are output, and enlarges the size of the first output area after results of translation performed by the second user are output.

13. The apparatus of claim 12, wherein:
the UI generation unit generates a voice recognition result UI corresponding to results of voice recognition when the translation target is voice input from the user, and generates a candidate voice recognition result UI corresponding to results of candidate voice recognition similar to the results of voice recognition when the user touches the voice recognition result UI output on the display unit, and
the translation target translation unit performs translation for the results of candidate voice recognition and generates the results of translation when the user touches the candidate voice recognition result UI.

14. The apparatus of claim 1, wherein the translation target translation unit generates the results of translation after reflecting proper nouns for a language of a geographic area corresponding to the location of the user based on the location of the user.

15. The apparatus of claim 1, wherein:
the UI generation unit generates a proper noun UI for selecting a proper noun of a specific geographic area to be reflected when the translation target translation unit generates the results of translation, and
the translation target translation unit generates the results of translation after reflecting the proper noun of the geographic area corresponding to the proper noun UI touched by the user.

16. The apparatus of claim 15, wherein:
the proper noun UI is a globe-shaped UI comprising a plurality of geographic areas, and
the translation target translation unit generates the results of translation by reflecting a proper noun corresponding to a geographic area selected in such a way that the user rotates the globe-shaped UI through touching and dragging.

17. A method for automatic translation comprising:
generating, by an UI generation unit, UIs necessary for start of translation and a translation process;
receiving, by a translation target input unit, a translation target to be translated from a user;
performing translation, by a translation target translation unit, on the translation target received in receiving and generating results of translation; and
outputting, by a display unit, the results of translation and the UIs in accordance with a location of the user.

18. The method of claim 16, wherein generating the results of translation comprises:
generating a plurality of different results of translation performed on the translation target;
generating translation result UIs corresponding to a number of the plurality of different results of translation; and outputting the translation result UIs after generating the results of translation.

19. The method of claim 18, further comprising, after outputting the translation result UIs, outputting the plurality of different results of translation when the user touches the translation result UIs.

20. The method of claim 17, wherein outputting the translation result UIs comprises simultaneously outputting a first output area configured to include a first translation result and a first UI and a second output area vertically inverted from the first output area.
